(19) United States
(12) Patent Application Publication
(10) Pub. No.: US 2025/0274386 A1
(43) Pub. Date: Aug. 28, 2025

(54) Patch Panels Using Static MPLS Pseudowire Tunnels

(71) Applicant: Arista Networks, Inc., Santa Clara, CA (US)

(72) Inventors: Shriprama Rao, Austin, TX (US); Avishek Santhaliya, Austin, TX (US); Kaushik Kumar Ram, San Jose, CA (US)

(21) Appl. No.: 18/588,818

(22) Filed: Feb. 27, 2024

(51) Int. Cl. H04L 45/50

(52) U.S. Cl. CPC H04L 45/50; H04L 2212/00

(57) ABSTRACT

The present disclosure describes encapsulating (and decapsulating) Layer 2 traffic from a given interface or subinterface over a Layer 3 tunnel; e.g., a Generic Routing Encapsulation (GRE) tunnel. A Multiprotocol Label Switching (MPLS) label is added to identify the ingress interface, and the GRE tunnel is used to transport the packets to a remote endpoint.

### BACKGROUND

The present disclosure relates generally to network pseudowires. The term “pseudowire” refers to networking technique where a circuit is emulated in an existing network. A pseudowire can be viewed as virtual wire on an existing packet-switched network (PSN). From the point of view of a service provider, a pseudowire begins at one edge of a packet-switched network and ends at another edge of the network. Pseudowires can carry suitable Layer 2 packets such as Ethernet, asynchronous transfer mode (ATM), frame relay, and the like. The underlying packet-switched network can use any suitable routing technique, such as for example, version 4 Internet Protocol (IPv4) and version 6 Internet Protocol (IPv6) protocols, and other Layer 3 routing technologies.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is an illustrative system in accordance with some embodiments.

FIGS. 2A and 2B illustrate an example configuration in accordance with some embodiments.

FIG. 3 represents an illustrative example of a flow of operations in accordance with some embodiments.

FIGS. 4A-4D represent illustrative examples of packet encapsulation in accordance with some embodiments.

FIG. 5 represents an illustrative example of packet flow in accordance with some embodiments.

FIG. 6 represents an illustrative example of a network device in accordance with some embodiments.

### DETAILED DESCRIPTION

The present disclosure relates to delivering packets using a pseudowire to send Layer 2 (L2) traffic over a Layer 3 (L3) tunnel to an endpoint (remote) device in conjunction with a patch panel mechanism to patch packets from the ingress interface to the pseudowire. Further in accordance with the present disclosure, return traffic can be handled by stripping (decapsulating) L3 encapsulation and forwarding the traffic back to their source. The patch panel connects the ingress interface to the pseudowire so that all the packets coming in through the interface gets tunneled via the pseudowire, and all the tunneled packets coming across the pseudowire can be decapsulated and forwarded to the interface. Persons of ordinary skill in the art will understand that a physical port can be a single interface or can be logically partitioned into multiple subinterfaces. Packets received on a subinterface level, for example, can be identified by specific dot1q/dot1ad tags (e.g., per IEEE 802.1Q) that the packets come in with. The notation “(sub) interface” will be used to refer to either an interface on a port that is configured with a single interface or to one of several subinterfaces on a port that is partitioned into multiple interfaces.

As used in the present disclosure, a patch panel refers to a software-based mechanism that runs on a network device for patching or establishing a connection between two (or more) connectors on the network device. In some embodiments, the “connector” can be specified as a (sub) interface on the network device. In other embodiments, the connector can be specified as one end of a pseudowire. The connection can be referred to as a virtual or logical patch (referred to herein simply as “patch”). The patch is “virtual” in that the connection is internal to the network device. A virtual patch between two connectors on the network device can be established using software-controlled hardware in the network device, such as a cross-connect circuit. By comparison, a physical patch refers to a connection made by connecting together external ports (e.g., RJ45 couplers) of the network device with an external cable (e.g., an Ethernet cable that is external to the network device).

In accordance with the present disclosure, a first connector on the network device is patched (connected) by way of the patch to a second connector on the network device. The first connector is a (sub) interface on the network device. The second connector can be one end of a wire, the other end of which is connected to or otherwise associated with a tunnel to transport traffic to an endpoint device separate from the network device at the other end of the tunnel.

In accordance with the present disclosure, the pseudowire can be characterized by one or more MPLS labels, referred to herein as local and neighbor labels. In some embodiments, packets that ingress the network device on a pseudowire can use an MPLS label (local label) associated with the pseudowire to determine which (sub) interface on the network device to forward the ingress packet. Likewise in some embodiments, an endpoint device at the other end of the pseudowire that receives packets on the pseudowire can use the MPLS label (neighbor label) associated with the pseudowire to determine how to process or otherwise handle the packets.

In some embodiments, packets received from a source connected to a (sub) interface (first connector) of the network device are patched to a pseudowire (second connector) which is connected to a tunnel. The MPLS labels and appropriate routing headers are added to the packet which is then transmitted over the tunnel to an endpoint device at the other end of the tunnel. Conversely, packets sent from the endpoint device and received at the second connector are stripped of the MPLS labels and routing headers, and transmitted over the patch to the first connector back to the source.

The underlying transport mechanism used with the pseudowire can be based on a tunneling protocol, such as GRE, Virtual Extensible Local Area Network (VxLAN), IP-in-IP, IP Security (IPSec), L2 Tunneling Protocol (L2TP), Point-to-Point Tunneling Protocol (PPTP), Secure Socket Tunneling Protocol (SSTP), Generic UDP Encapsulation (GUE), etc., on a suitable routing protocol (e.g., IPv4, IPv6, etc.). For discussion purposes, GRE will serve as the illustrative example of the tunneling mechanism.

The workflow in accordance with some embodiments of the present disclosure can proceed as follows:
A user specifies a patch between one connector on the network device (i.e., a (sub) interface) and one end of a pseudowire.
The pseudowire can be defined in terms of a tunnel as its transport mechanism (e.g., GRE tunneling protocol, source and destination addresses, etc.) and can be characterized by one or more static MPLS labels. The MPLS label is “static” in that the label is not allocated by protocols such as Label Distribution Protocol (LDP), Ethernet Virtual Private Network (EVPN) with Virtual Private Wire Service (EVPN-VPWS), or the like which allocate labels based on network topology and hence can change with network topology. A static MPLS label in accordance with the present disclosure can be selected by user or by an automated process running on the network device itself or on a device (e.g., network controller) separate from the network device. A pseudowire defined by static MPLS labels can be referred to as a static MPLS pseudowire, or simply a static pseudowire.
Generally, two MPLS labels can be allocated, one for each end of the pseudowire. The labels can be referred to as a local MPLS label (also referred to herein as local label) and a neighbor MPLS label (also referred to herein as neighbor label) and are used by the network device. In some embodiments, a single label value can be used for both the local label and the neighbor label. For example, in some embodiments where the remote endpoint device is a reflector that reflects packets back to the sender, then a single label can be used for packets sent to the endpoint device and for packets reflected back by the endpoint device.
The MPLS labels can be manually programmed or randomly selected in the network device and in the endpoint device by the user, for example, by a human user or by an automated process (e.g., running on a management controller). In some embodiments, the patch can be configured in the network device and in the endpoint device where the local and neighbor labels can be programmed in reverse order on the endpoint device. For example, if the network device has local label 100 and neighbor label 200, then the endpoint device will have local label 200 and neighbor label 100.

Packet processing can proceed as follows:
Generally, when the network device (sending device) receives a packet that is to be sent on the pseudowire to the endpoint device, an MPLS label (e.g., 1000) that corresponds to the endpoint device is added to the packet, followed by GRE encapsulation. The encapsulated packet is then sent over the GRE tunnel.
The endpoint device receives the packet and processes or otherwise handles the packet. Depending on the endpoint device, processing the packet may be based on the value of the MPLS label.
The endpoint device can send a (return) packet back to the sending device. A label (e.g., 2000) that corresponds to the sending device can be added to the return packet. Upon receiving the return packet, the network device will see its local label contained in the return packet, informing the network device to forward the packet on the (sub) interface associated with that label.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

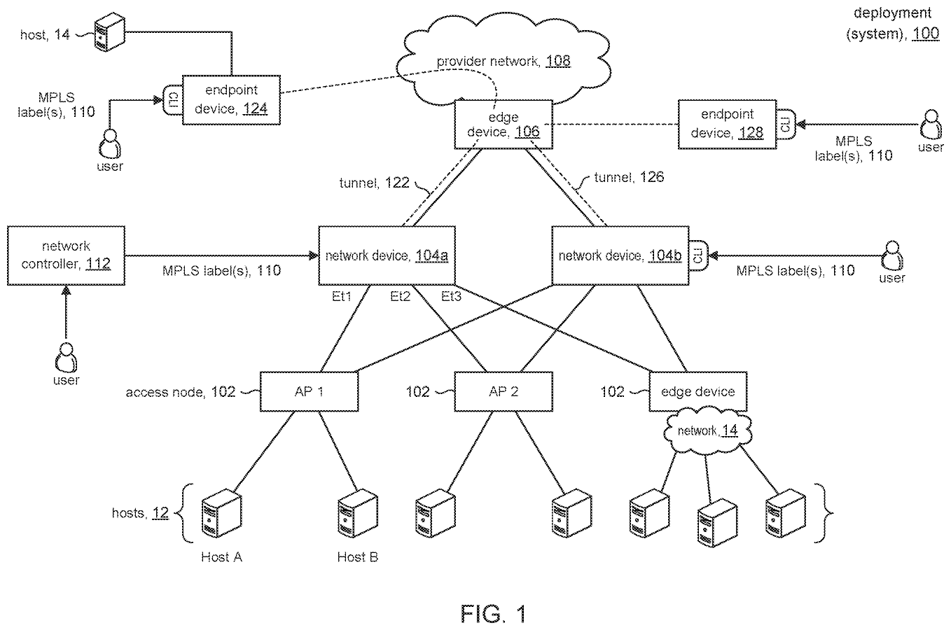

FIG. 1 is a high level diagram illustrating an example deployment (system) 100 that can embody the techniques in accordance with the present disclosure. The system 100 can support network communication among hosts 12 such as clients (users), servers, and the like. In some embodiments, such as shown in FIG. 1, system 100 can be configured in a spine-leaf architecture. Hosts 12 can be connected to access nodes 102. Access nodes 102 can include wireless access points (e.g., AP 1, AP 2) to provide hosts with access to wireless communication. Access nodes 102 can include a client edge device on client network 14 in a data center.

Access nodes 102, in turn, can be connected to a distribution layer comprising network devices (distribution devices) 104a, 104b (collectively 104). The network devices 104 can be connected to a core layer, which in the example in FIG. 1 comprises an edge device 106, to provide access to a provider network 108.

In accordance with the present disclosure, the network devices 104 can be configured with a tunneling mechanism to tunnel packets to an endpoint device. In some embodiments, the endpoint device can be accessed via provider network 108. FIG. 1, for example, shows that network device 104a can establish a tunnel 122 to endpoint device 124 via provider network 108. In other embodiments, the endpoint device can be reached directly from the network device 104. FIG. 1, for example, shows that network device 104b can establish a tunnel 126 to directly reach endpoint device 128 without traversing the provider network.

In accordance with some embodiments of the present disclosure, user-defined, user-provided MPLS labels 110 can be distributed and programmed in the network devices 104 via a centralized network controller 112. An example of a network controller is the CloudVision® network management platform developed and sold/licensed by Arista Networks, Inc. of Santa Clara, California; although it will be understood that embodiments in accordance with the present disclosure can be used in other controllers. In other embodiments, the MPLS labels 110 can be programmed directly by a user, for example, via a suitable command line interface (CLI). In some embodiments, MPLS labels 110 comprise a local label and a neighbor label. In some embodiments, the local and neighbor labels have the same value, and in other embodiments, the local and neighbor labels have different values. Further in accordance with the present disclosure, a user (human or computer) can program MPLS labels 110 into endpoint devices 124, 128.

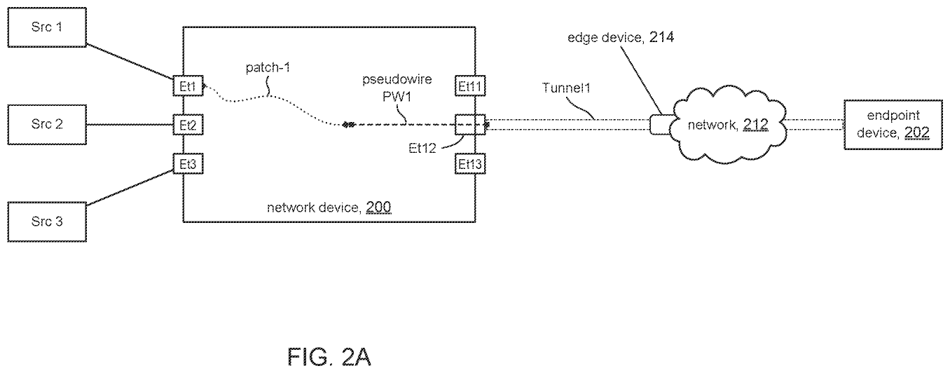

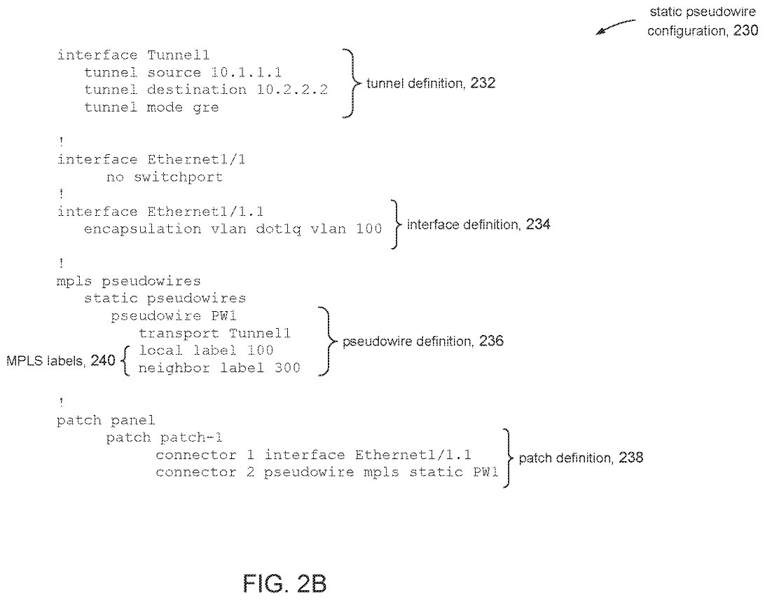

FIGS. 2A and 2B show additional details of processing in a network device in accordance with some embodiments. Network device 200 shown in FIG. 2A can be configured in accordance with static MPLS pseudowire configuration 230 shown in FIG. 2B. The configuration 230 defines elements in network device 200 for operation in accordance with the present disclosure, including a static MPLS pseudowire (PW1) that connects the network device 200 and a remote endpoint device 202, a tunnel (Tunnel) as the underlying transport mechanism for the pseudowire, and a patch (patch-1) that connects a (sub)interface on the network device to one end of pseudowire PW1. Configuration information in configuration 230 includes:
pseudowire definition 236—A pseudowire definition defines a static MPLS pseudowire in accordance with the present disclosure. The pseudowire definition 236 defines a static MPLS pseudowire identified as PW1. The pseudowire is “static” in that it is associated with static MPLS labels. In accordance with the present disclosure, static MPLS labels are selected independently of network topology and remain unchanged despite changes in network topology. In accordance with the present disclosure, static MPLS labels are not used for switching in an MPLS network, and so can be used in deployed networks that do not include an MPLS network.
In some embodiments, static MPLS labels can be selected by a user, for example, from a block of MPLS labels that is shared by all static MPLS routes in the network. In other embodiments, static MPLS labels can be automatically allocated by an automated process from a label space reserved for pseudowires. The automated process can be running on the network device itself or on a device (e.g., a network controller) separate from but in communication with the network device.
The pseudowire definition 236 specifies a transport mechanism, namely Tunnel1, to carry traffic that is transmitted over the pseudowire. As noted above, the GRE tunneling protocol will be used as an example, with the understanding that the tunneling mechanism can be based on any suitable tunneling protocol. FIG. 2A shows that one end of the pseudowire resolves to interface Et12 on the network device which is one end of Tunnel1. The other (remote) end of Tunnel1 terminates at a remote endpoint device.
The pseudowire definition 236 includes user-selected or automatically allocated static MPLS labels 240 comprising a local label and a neighbor label. In accordance with the present disclosure, the local label identifies which (sub) interface on the network device the packet came in on. In some embodiments, the neighbor label can be used by the endpoint device to determine which pseudowire the packet came in on and how to process or otherwise handle the packet.
In accordance with the present disclosure, the MPLS labels 240 can be user-selected or automatically allocated by an automated process, and is not negotiated in accordance with a protocol such as LDP, EVPN-VPWS, and the like. In other words, the MPLS labels are selected independently of an MPLS network. Moreover, MPLS labels are static in that they remain unchanged despite any changes in the network. In some embodiments, the user can select MPLS labels from a block of MPLS labels that is shared between all static MPLS routes in the network so as to avoid conflicts in configurations where MPLS labels are also being used for other protocols such as BGP/IS-IS. In accordance with some embodiments, the local and neighbor label values are programmed both in the network devices and in the endpoint device. It will be understood that the term “label” as used herein (e.g., MPLS label, neighbor label, local label) will refer to statically obtained MPLS labels as described above and not to MPLS labels obtained by a protocol.
tunnel definition 232—A tunnel definition defines a tunnel between the network device and a remote endpoint device. The tunnel definition 232, identified as Tunnel1, specifies a transport mechanism for carrying traffic on pseudowire PW1 between the network device and the remote endpoint device. The tunnel is characterized by a source IP address that identifies network device 200 at one end of the tunnel and a destination IP address that identifies endpoint device 202 at the other end of the tunnel. In some embodiments (such as shown in FIG. 2A), the endpoint device is reached through network 212 via edge device 214. In other embodiments (not shown), the endpoint device can be reached directly from network device 200.
patch definition 238-A patch definition defines a patch between connectors, e.g., (sub) interfaces on the network device. The patch definition 238 defines a patch, identified as patch-1, between a (sub) interface on the network device and one end of pseudowire PW1. The (sub) interface on the network device that the pseudowire PW1 resolves to can be determined based on the tunnel destination. The example in FIGS. 2A and 2B, for instance, show the destination for Tunnel1 is 10.2.2.2. We can determine that 10.2.2.2 is reachable via Et12 using the underlay IP routing protocol (e.g., BGP, OSPF, IS-IS, etc.) in conjunction with the Address Resolution Protocol (ARP). The example in FIGS. 2A and 2B show that patch-1 is connected to subinterface Et1/1.1 and interface Et12 (the resolved end of pseudowire PW1). Packets coming in on subinterface Et1/1.1 can be patched by patch-1 to pseudowire PW1 and then tunneled to the endpoint device over Tunnel1 via Et12. Conversely, tunneled packets received from the endpoint device over Tunnel1 arrive on Et12 and can be decapsulated and patched to subinterface Et1/1.1.
interface definition 234—An interface definition defines an interface on a port of the network device, or a subinterface of a port if the port is partitioned into several subinterfaces. The interface definition 234 defines a subinterface, identified as Et1/1.1, on routed port Et1 of the network device 200. In the example shown in FIGS. 2A and 2B, traffic on subinterface Et1/1.1 comprises packets that are VLAN tagged according to IEEE 802.1Q with a VLAN tag identifier of 100.

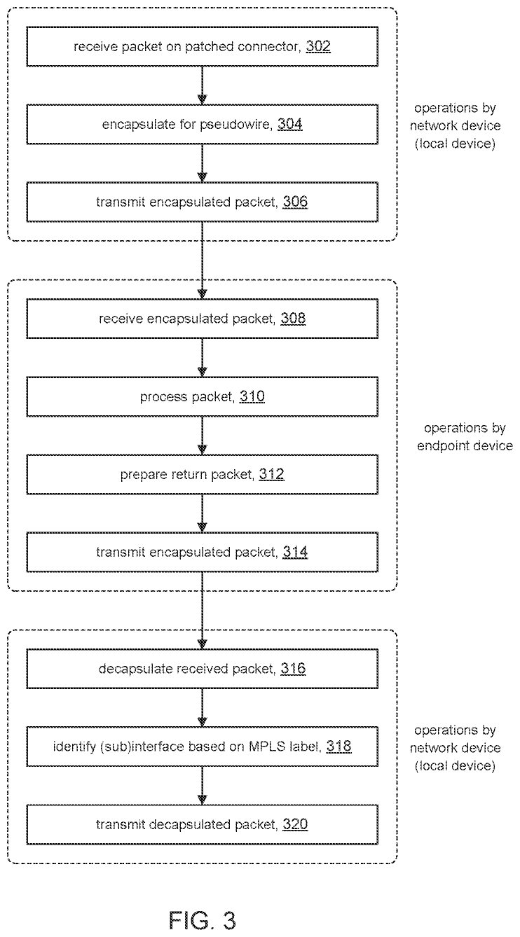

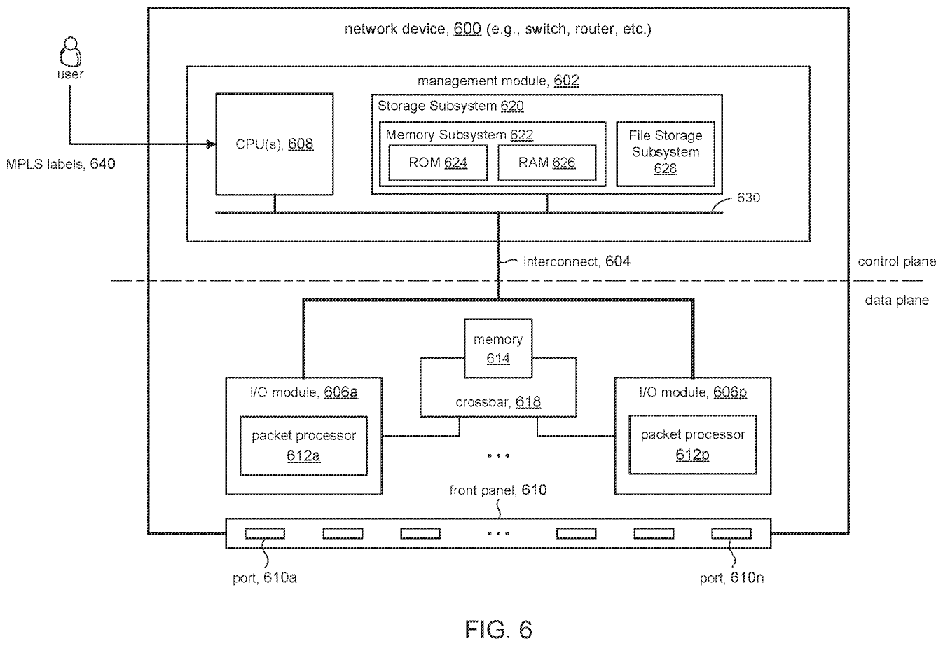

Referring to FIG. 3, the discussion will now turn to a high-level description of processing in a network device (e.g., network device 104) in accordance with the present disclosure. Depending on a given implementation, the processing may be performed entirely in the control plane of the network device or entirely in the data plane of the network device, or the processing may be divided between the control plane and the data plane. In some embodiments, the network device can include one or more processing units (circuits), which when operated, can cause the network device to perform processing in accordance with FIG. 3. Processing units (circuits) in the control plane, for example, can include general CPUs that operate by way of executing computer program code stored on a non-volatile computer readable storage medium (e.g., read-only memory); e.g., CPU 608 in the control plane (FIG. 6) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 612a-612p in the data plane (FIG. 6) can be a specialized processor.

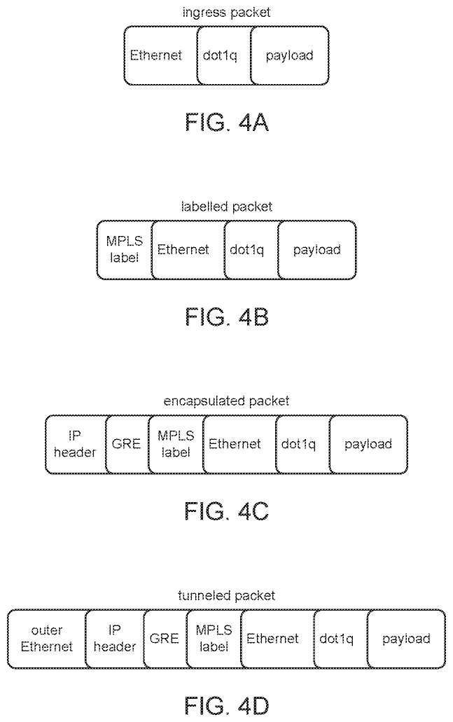

The operation and processing blocks described below are not necessarily executed in the order shown. Operations can be combined or broken out into smaller operations in various embodiments. Operations can be allocated for execution among one or more concurrently executing processes and/or threads. The operations will be described in the context of the configuration shown in FIGS. 2A and 2B and with reference to the encapsulation examples illustrated in FIGS. 4A-4D.

### Operations by (Local) Network Device

At operation 302, the network device can receive a (ingress) packet from a source. FIG. 4A is a generalized representation of a tagged ingress packet that can be received from the source. Using the example in FIGS. 2A and 2B, the source can be Src 1 connected to port Et1. In some embodiments, Src 1 can be an access point such as shown in FIG. 1 to which host machines (clients, servers, etc.) are connected. In other embodiments, Src 1 can be the host machine itself. Suppose for discussion purposes that Src 1 transmits a packet on a VLAN with a VLAN ID of 100. The static MPLS pseudowire configuration 230 informs the network device that the received ingress packet, tagged with VLAN ID 100, arrived on a subinterface defined on port Et1, namely subinterface Ethernet1/1.1. In addition, based on configuration 230, the network device can determine that subinterface Ethernet1/1.1 (connector 1) is patched to pseudowire PW1 (connector 2) per the patch definition 238.

At operation 304, the network device can encapsulate the ingress packet for transport on pseudowire PW1. In accordance with the present disclosure, the network device can add a user-selected or automatically allocated neighbor label to the packet, which as explained above, can serve to inform the endpoint device which pseudowire the tunneled packet came in on and hence how to process the packet. FIG. 4B is a generalized representation of a labeled packet comprising an ingress packet associated with an MPLS label. Continuing with the configuration example shown in FIG. 2B, the MPLS label can be the neighbor label ‘300’.

The labeled packet can then be encapsulated for tunneling, per the patch definition 238. In our example the labeled packet is encapsulated in accordance with GRE protocol, although it will be appreciated that any suitable tunneling protocol can be used. The encapsulation can include setting the IP address of the network device as the source IP (SIP) address in an IP header (one end of the GRE tunnel) and setting the destination IP (DIP) address in the IP header to the IP address of the endpoint device (the other end of the GRE tunnel). FIG. 4C is a generalized representation of a GRE encapsulated packet. Continuing with the configuration example shown in FIG. 2B, the SIP address is 10.1.1.1 and the DIP address is 10.2.2.2.

At operation 306, the network device can transmit the encapsulated packet to the endpoint device. Referring to FIG. 2A, the network device can transmit the encapsulated packet to an edge device (214) and onto network (212) to reach the endpoint device (202). As noted above, in some embodiments, the endpoint device can be directly reachable from the network device. FIG. 4D is a generalized representation of a tunneled packet, where the GRE encapsulated packet is encapsulated in an Ethernet frame. Continuing with the configuration example shown in FIGS. 2A and 2B, the pseudowire resolves to port Et12, so the encapsulated packet is transmitted on interface Et12.

### Operations by Endpoint Device

At operation 308, the endpoint device can receive the tunneled packet which encapsulates the ingress packet (from operation 302) and the added MPLS label.

At operation 310, the endpoint device can process the received tunneled packet, including for example decapsulating the packet. In some embodiments, the endpoint device can treat all packets in the same way. In other embodiments, processing by the endpoint device may vary based on the MPLS label added to the ingress packet. For example, recall from operation 304 that the MPLS label is neighbor label ‘300’. The endpoint device can be programmed with a neighbor label value ‘300’ so that it can know what actions to take on packets labeled ‘300’. In some embodiments, for example, the endpoint device can filter and drop certain packets, snoop the packets and keep track of some metric, log the presence of certain packets, and so on. In other embodiments, the endpoint device can be a reflector that simply returns the received packets back to the sender. In still other embodiments, the endpoint device can forward the packets to a host connected to the endpoint device. FIG. 1, for example, shows a host 14 connected to endpoint device 124. The configuration of endpoint device 124 shown in FIG. 1 allows for host-to-host communication, for instance, between Host A and host 14, where host 14 can be connected to endpoint device 124 by a direct connection (as shown in FIG. 1) or via an intermediate network (not shown).

At operation 312, the endpoint device can generate a return packet. In some embodiments, for example, the return packet may be the ingress packet itself (as in the case of a reflector). In the case where a host is connected to the endpoint device (e.g., host 14 connected to endpoint device 124, FIG. 1), the return packet can be part of the traffic between the endpoint host and a host on the local network device. The return packet can be processed in accordance with the present disclosure including:
The MPLS label in the return packet can be set to the value of the local label that corresponds to the network device. For example, the value of the local label can be programmed in the endpoint device. Continuing with the configuration example shown in FIG. 2B, the local label is ‘100’.
The packet can be tunneled to the network device via the GRE tunnel. Using the configuration example shown in FIG. 2B, the tunneled packet received by the endpoint device has a SIP of 10.1.1.1 and a DIP of 10.2.2.2. Accordingly, on the return trip, the return packet can be tunneled on the GRE tunnel with a DIP of 10.1.1.1.

At operation 314, the endpoint device can transmit the encapsulated return packet to the network device, or in some embodiments, the return packet can be transmitted to a device other than the network device.

### Operations by (Local) Network Device

At operation 316, in an embodiment where the endpoint device transmits a return packet, the network device can decapsulate the packet received from the endpoint device to recover the return packet including the MPLS label added by the endpoint device, which in our example is local label ‘100’. In our example, the return packet from the endpoint device will ingress on interface Et12.

At operation 318, the network device can identify the (sub) interface on which to forward the return packet based on the recovered MPLS label. In our example, using configuration 230, the local label ‘100’ maps to subinterface Ethernet/1/1.1, and so the return packet will be forwarded to subinterface Ethernet1/1.1.

At operation 320, the network device can transmit the recovered return packet on the identified (sub) interface to the source, which in our example is Src 1. It will be appreciated that in a more general use case, the network device can forward the packet to another destination instead of (or in addition to) Src 1, the network device can drop the packet, etc.

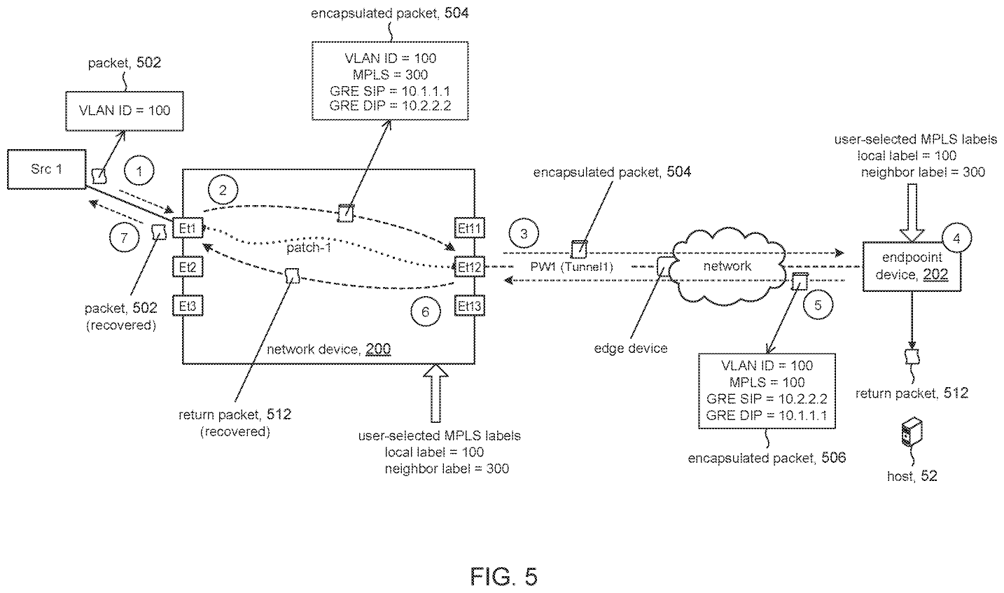

FIG. 5 represents an illustrative data flow in accordance with the operations of FIG. 3 and using the configuration shown in FIGS. 2A and 2B. At time reference 1 (indicated by the circled numeral 1), Src 1 transmits a packet 502 that is received on port Et1 of network device 200 (operation 302). Assuming, without loss of generality, the packet 502 is tagged with VLAN ID 100, then at time reference 2, the network device determines that packet 502 arrived on subinterface Ethernet1/1.1 and generates encapsulated packet 504 for transport in a GRE tunnel comprising a labeled packet that includes user-selected or automatically allocated MPLS neighbor label ‘300’ (operation 304). At time reference 3, the encapsulated packet 504 is sent over the GRE tunnel, Tunnel1, to endpoint device 202 (operation 306) by virtue of subinterface Ethernet1/1.1 being patched to the PW1.

At time reference 4, the endpoint device receives and processes or otherwise handles the tunneled packet (operations 308, 310). At time reference 5, the endpoint device generates a return packet 512 and prepares an encapsulated packet 506 that comprises the generated return packet and the user-selected or automatically allocated local label ‘100’ (operation 312). Note the swapped IP addresses in the encapsulated packet 506. The packet 506 is transmitted over the GRE tunnel (operation 314) and received by the network device.

At time reference 6, the network device decapsulates the received tunneled packet 506 to recover the return packet 512 and the MPLS label (operation 316). The network device determines, based on the recovered MPLS label and the static MPLS pseudowire configuration 230, that the recovered original packet 502 should be forwarded to the Ethernet1/1.1 subinterface (operation 318), and at time reference 7 transmits the packet back to Src 1 (operation 320).

In the use case of a host-to-host configuration, where Src1 communicates with a host 52 at endpoint device 202, the return packet 512 can come from host 52 as part of the host-to-host communication between Src1 and host 52. It is noted that in some embodiments, endpoint device 202 can be configured with a patch and pseudowire configuration in a manner similar to Src1 and network device 200, in which case the endpoint device 202 basically repeats the operations at time reference 1, 2, and 3, but in the direction from the endpoint device toward the network device.

FIG. 6 is a schematic representation of a network device 600 (e.g., a network device, a router, switch, and the like) that can be adapted in accordance with the present disclosure. In some embodiments, for example, network device 600 can include a management module 602, one or more I/O modules (switches, switch chips) 606a-606p, and a front panel 610 of I/O ports (physical interfaces, I/Fs) 610a-610n. Management module 602 can constitute the control plane of network device 600 (also referred to as the control layer or simply the central processing unit, CPU), and can include one or more CPUs 608 for managing and controlling operation of network device 600 in accordance with the present disclosure. Each CPU 608 can be a general-purpose processor, such as an Intel®/AMD® x86, ARM® microprocessor and the like, that operates under the control of software stored in a memory device/chips such as read-only memory (ROM) 624 or random-access memory (RAM) 626. The control plane provides services that include traffic management functions such as routing, security, load balancing, analysis, and the like.

The one or more CPUs 608 can communicate with storage subsystem 620 via bus subsystem 630. Other subsystems, such as a network interface subsystem (not shown in FIG. 6), may be on bus subsystem 630. Storage subsystem 620 can include memory subsystem 622 and file/disk storage subsystem 628. Memory subsystem 622 and file/disk storage subsystem 628 represent examples of non-transitory computer-readable storage devices that can store program code and/or data, which when executed by one or more CPUs 608, can cause one or more CPUs 608 to perform operations in accordance with embodiments of the present disclosure.

Memory subsystem 622 can include a number of memories such as main RAM 626 (e.g., static RAM, dynamic RAM, etc.) for storage of instructions and data during program execution, and ROM (read-only memory) 624 on which fixed instructions and data can be stored. File storage subsystem 628 can provide persistent (i.e., non-volatile) storage for program and data files, and can include storage technologies such as solid-state drive and/or other types of storage media known in the art.

CPUs 608 can run a network operating system stored in storage subsystem 620. A network operating system is a specialized operating system for network device 600. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used. The CPUs 608 can provide a CLI or a machine interface to receive user-selected or automatically allocated MPLS labels 640 in accordance with the present disclosure.

Bus subsystem 630 can provide a mechanism for the various components and subsystems of management module 602 to communicate with each other as intended. Although bus subsystem 630 is shown schematically as a single bus, alternative embodiments of the bus subsystem can utilize multiple buses.

The one or more I/O modules 606a-606p can be collectively referred to as the data plane of network device 600 (also referred to as the data layer, forwarding plane, etc.). Interconnect 604 represents interconnections between modules in the control plane and modules in the data plane. Interconnect 604 can be any suitable bus architecture such as Peripheral Component Interconnect Express (PCIe), System Management Bus (SMBus), Inter-Integrated Circuit (I2C), etc.

I/O modules 606a-606p can include respective packet processing hardware comprising packet processors 612a-612p (collectively 612) to provide packet processing and forwarding capability. Each I/O module 606a-606p can be further configured to communicate over one or more ports 610a-610n on the front panel 610 to receive and forward network traffic. Packet processors 612 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 612 can include forwarding lookup hardware such as, for example, but not limited to content addressable memory such as ternary CAMs (TCAMs) and auxiliary memory such as static RAM (SRAM).

Memory hardware 614 can include buffers used for queueing packets. I/O modules 606a-606p can access memory hardware 614 via crossbar 618. It is noted that in other embodiments, the memory hardware 614 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

The invention claimed is:

1. A method in a network device, the method comprising:
receiving a local Multiprotocol Label Switching (MPLS) label and a neighbor MPLS label, wherein the local MPLS label is associated with a given interface on the network device, wherein the neighbor MPLS label is associated with a remote device;
in response to receiving a first packet on the given interface of the network device, the network device:
generating a tunneled packet by encapsulating the first packet and the neighbor MPLS label; and
transmitting the tunneled packet to the remote device to be processed by the remote device including the remote device transmitting a return packet; and
in response to receiving the return packet from the remote device, the network device:
decapsulating the return packet to recover a second packet and an MPLS label encapsulated in the return packet; and
transmitting the recovered second packet on the given interface in response to a determination that the recovered MPLS label is equal to the local MPLS label.

2. The method of claim 1, wherein the network device is deployed in a network that does not include an MPLS network.

3. The method of claim 1, wherein the tunneled packet is transmitted to the remote device without using MPLS protocol.

4. The method of claim 1, further comprising receiving the local and neighbor MPLS labels from a user.

5. The method of claim 4, wherein the user is a human user or an automated process running on a network management system.

6. The method of claim 1, wherein the local and neighbor MPLS labels are generated by the network device.

7. The method of claim 1, wherein the local and neighbor MPLS labels have the same value.

8. The method of claim 1, wherein the remote device processes the tunneled packet based on the neighbor MPLS label contained in the tunneled packet.

9. The method of claim 1, wherein a first host is connected to the network device and a second host is connected to the remote device, wherein the first packet and the return packet are part of a communication between the first host and the second host.

9. A network device comprising:
a plurality of interfaces;
one or more computer processors; and
a computer-readable storage device comprising instructions for controlling the one or more computer processors to:
receive a packet (ingress packet) on an interface (ingress interface) of the network device;
identify a pseudowire associated with the ingress interface;
generate a tunneled packet comprising the ingress packet and a first user-selected MPLS label;
transmit the tunneled packet to a remote device associated with the pseudowire;
receive a return packet from the remote device;
identify an interface (egress interface) using a second user-selected MPLS label contained in the return packet; and
transmit at least a portion of the return packet on the identified egress interface.

11. The network device of claim 10, wherein the computer-readable storage device further comprises instructions for controlling the one or more computer processors to receive first and second user-selected MPLS labels from a user.

10. The network device of claim 10, wherein the ingress interface is patched to the pseudowire.

11. The network device of claim 10, wherein the ingress interface and the egress interface are the same interface.

12. The network device of claim 10, wherein the first and second user-selected MPLS labels are the same.

13. A method in a network management system to manage sending packets on a pseudowire, the method comprising the network management system:
receiving a local MPLS label and a neighbor MPLS label from a user, wherein the local MPLS label is associated with a given interface on a first network device, wherein the neighbor MPLS label is associated with a second network device; and
communicating the local and neighbor MPLS labels to the first network device to be stored in the first network device,
wherein in response to the first network device receiving a first packet on the given interface of the first network device, the first network device:
adds the neighbor MPLS label to the first packet;
encapsulates the first packet with the added neighbor MPLS label in a tunneling protocol to produce an outgoing packet; and
transmits the outgoing packet to the second network device.

14. The method of claim 15, wherein a packet from the second network device is transmitted by the second network device in response to the second network device receiving the outgoing packet from the first network device, wherein in response to the first network device receiving the packet from the second network device, the first network device:
decapsulates the incoming packet to obtain a second packet and an MPLS label, wherein the MPLS label is equal to the local MPLS label; and
in response to the MPLS label equaling the local MPLS label, transmits the second packet on the given interface associated with the local MPLS label.

15. The method of claim 15, wherein the local and neighbor MPLS labels are the same label.

16. The method of claim 15, wherein the user is a human user or an automated process running on the network management system.

17. The method of claim 15, further comprising the network management system storing the local MPLS label of the first network device as a neighbor MPLS label in the second network device and storing the neighbor MPLS label of the first network device as a local MPLS label in the second network device, wherein in response to the second network device receiving the outgoing packet from the first network device, the second network device:
adds its neighbor MPLS label to the second packet;
encapsulates the second packet with the added neighbor MPLS label in a tunneling protocol to produce an outgoing packet; and
transmits the outgoing packet to the first network device.

18. The method of claim 15, wherein the network does not use MPLS.
